(19) United States
(12) Patent Application Publication
(10) Pub. No.: US 2019/0143378 A1
(43) Pub. Date: May 16, 2019

(54) COMPRESSED AIR WASH SYSTEM

(71) Applicant: Michael Bivens, Oxford, MI (US)

(72) Inventor: Michael Bivens, Oxford, MI (US)

(21) Appl. No.: 15/814,230

(22) Filed: Nov. 15, 2017

(51) Int. Cl. B08B 3/02; B05B 9/08

(52) U.S. Cl. CPC B08B 3/024; B60S 3/047; B08B 3/026; B05B 9/0822

(57) ABSTRACT

A mobile pressure wash system that comprises a mobile fluid storage cabinet comprised of at least one fluid storage tank coupled to an air compressor. The air compressor supplies pressurized air into a pressurized air line. An intertwined hose comprised of a fluid supply line and the pressurized air line. The air line connects to an air gun and the fluid line connects to the air gun. The air gun comprises a syphon tip, and the fluid line connects to the syphon tip to facilitate a pressure differential to syphon fluid from the at least one fluid storage tank to eject fluid under pressure when pressurized air flows through the air gun.

### CROSS-REFERENCE TO RELATED APPLICATION(S)

Not applicable

### BACKGROUND OF THE INVENTION

### 1. Field of Invention

The present invention relates to the wash systems, more particularly to a mobile compressed air wash system.

### 2. Description of Related Art

Many industrial, small machine repair and maintenance shops, tools used in different industries, and other commercial businesses utilize pressure washers to clean parts and components of machines, including engine parts, plant machinery, food processing tools and machines, and machinery. Every such facility, from automobile repair shops to nuclear power plants, use or have a need for using a pressure wash system.

A drawback of existing pressure washers is the required quantity of water used. Pressure washers use water flow through a narrowed pipe, hose, or nozzle (or combination of one or more) to generate a pressurized water flow exiting a nozzle. Typically, a hose with a nozzle attachment generating a pressurized stream is used to clean various components and/or large pieces of machinery. However, such conventional pressure washer system use large quantities and can require a lot of effort to wash away the waste water into a drain system. This further requires using large quantities of water.

Based on the foregoing, there is a need in the art a system, which facilitates pressure washing using smaller quantities of water. A system is needed that does not require using water pressurized only by itself flowing through narrowing water conduits (i.e., hoses).

### SUMMARY OF THE INVENTION

A mobile pressure wash system comprises a mobile fluid storage cabinet comprised of at least one fluid storage tank coupled to an air compressor, with the air compressor supplying pressurized air into a pressurized air line. The pressurized air line connecting to an air gun and a fluid line connecting to the air gun, the fluid line attached to the fluid storage tank. The air gun comprising a syphon tip, and the fluid line connecting to the syphon tip to facilitate a pressure differential to syphon fluid from the at least one fluid storage tank to eject fluid under pressure when pressurized air flows through the air gun and syphon tip. The air gun and the syphon together form a syphon gun.

The fluid comprises water, a cleaner, or a combination of water and cleaner.

The syphon tip comprises an attachable syphon tip interfaced with the air gun.

The air compressor comprises an air pressure in the range of 45 to 90 psi and a five gallon pressure tank storing pressurized air.

The fluid storage cabinet comprises at least two five gallon fluid storage tanks, a storage section, and hosing to facilitate movement of fluid through the system.

The fluid storage cabinet further comprises valves to control and regulate fluid flow.

The fluid storage tank includes at least one storage tank in the range between ¾ gallon and five gallons.

The fluid line and the air line comprise an intertwined hose connecting to the syphon gun.

Advantages:

1. Improved cleaning action of water.

2. Improved water economy.

3. Improved cleaning speed.

4. Improved control of spatter and cleaning-related mess.

5. Reduced need for extra cleaning equipment.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a top view of the major components, according to an embodiment of the present invention;

FIG. 2 is a an isolated exterior top view of the mobile water storage cabinet, according to an embodiment of the present invention;

FIG. 3 is a top view of the interior of the mobile water storage cabinet. according to an embodiment of the present invention;

FIG. 4 is an interior view of the arrangement of interior water and air hoses in the water storage cabinet, according to an embodiment of the invention; and

FIG. 5 is an enlarged view of the intertwined hoses and syphon gun, according to an embodiment of the invention.

### DETAILED DESCRIPTION OF PREFERRED EMBODIMENTS

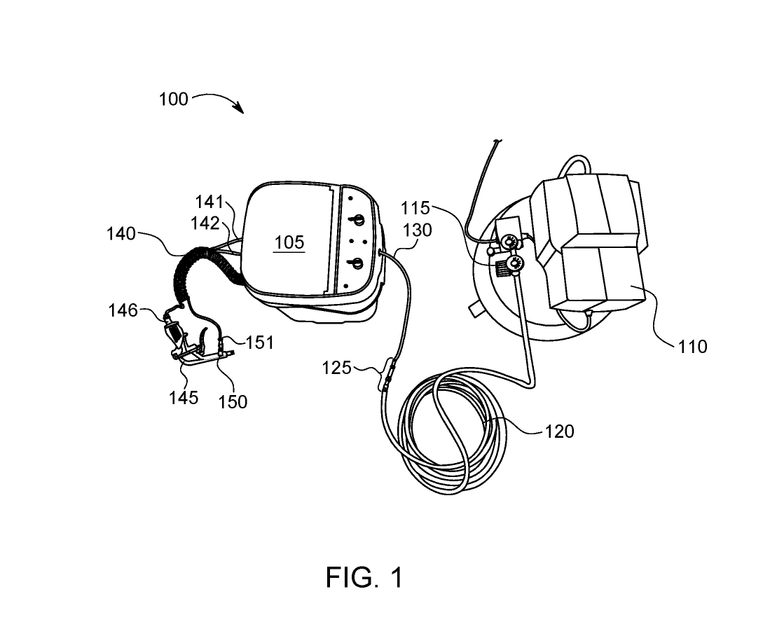

Preferred embodiments of the present invention and their advantages may be understood by referring to FIGS. 1-5, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows components of a mobile pressure wash system 100 according to an embodiment of the invention. Pressure wash system 100 can comprise a mobile water storage cabinet 105 that can store water for use, an air compressor/air storage tank 110 to pressurize the pressure water system 100, control and metering components 115 for the pressurized airflow through air hose 120, and coupling components 125 connecting air hose 120 to air line input 130 leading into mobile water storage cabinet 105.

Intertwined hoses 140 leading from mobile water storage cabinet 105 can comprise an air line output 141 and water line output 142, which can connect to an air gun 145, with a pressurized air line input connection 146 supplying pressurized air to the air gun 145. The air gun 145 can include a syphon tip 150 attached to the front of the air gun to create a syphon gun 145, with water line input connection 151 connected to syphon tip 150. When air/syphon gun 145 activates, pressurized air can flow from the air compressor/air storage tank 110 through hose 120, air line input 130, air line output 141, and air line input connection 146 to flow through syphon tip 150. The air flow past water line input connection 151 can create a low pressure differential in the water supply lines, so that water can flow through the water line output 142 into the syphon gun 145 for ejecting under pressure from the syphon gun 145.

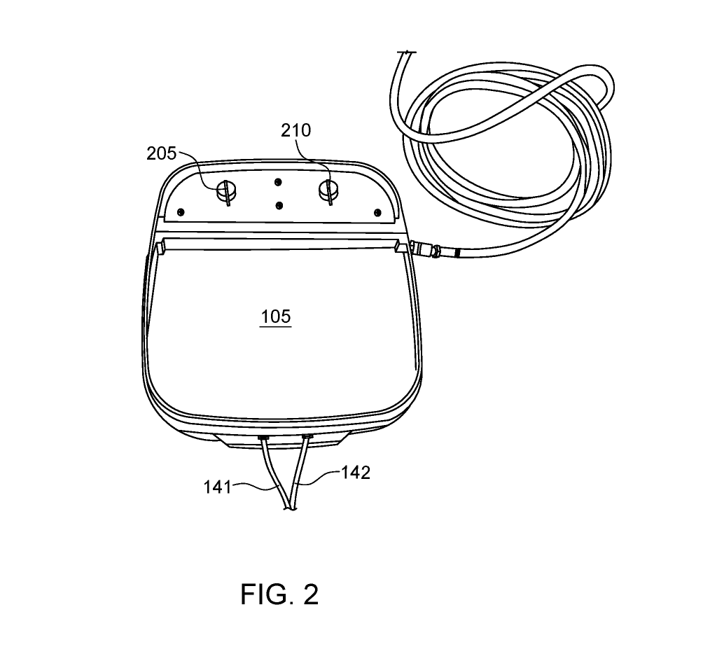

FIG. 2 depicts an isolated exterior top view of mobile water storage cabinet 105 in an embodiment. Mobile water storage cabinet 105 can include a pair of water valve controls 205 and 210. The water valve controls 205 and 210 can be used to control water flow through internal water hoses and internal water storage tanks (not shown).

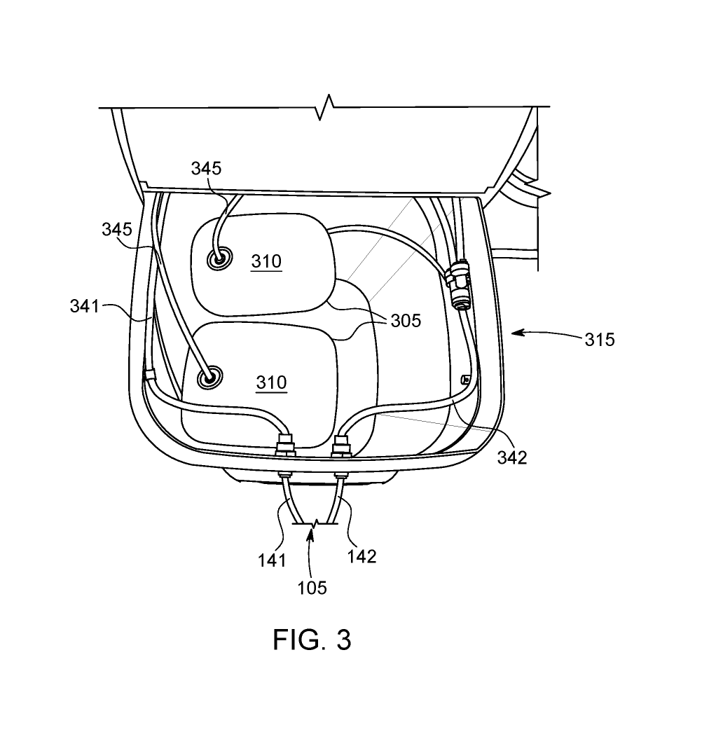

FIG. 3 shows an interior view of the mobile water storage cabinet 105. Water storage cabinet 105 can include a pair or water storage tanks 305 sealed by top covers 310. A void 315 to the side of water storage tanks 310 can be used to stow the intertwined hoses 140 and syphon gun 145. Air hose 341 supplies air to air line output 141 and water hose 342 supplies water syphoned from water storage tanks 310 to water line output 142.

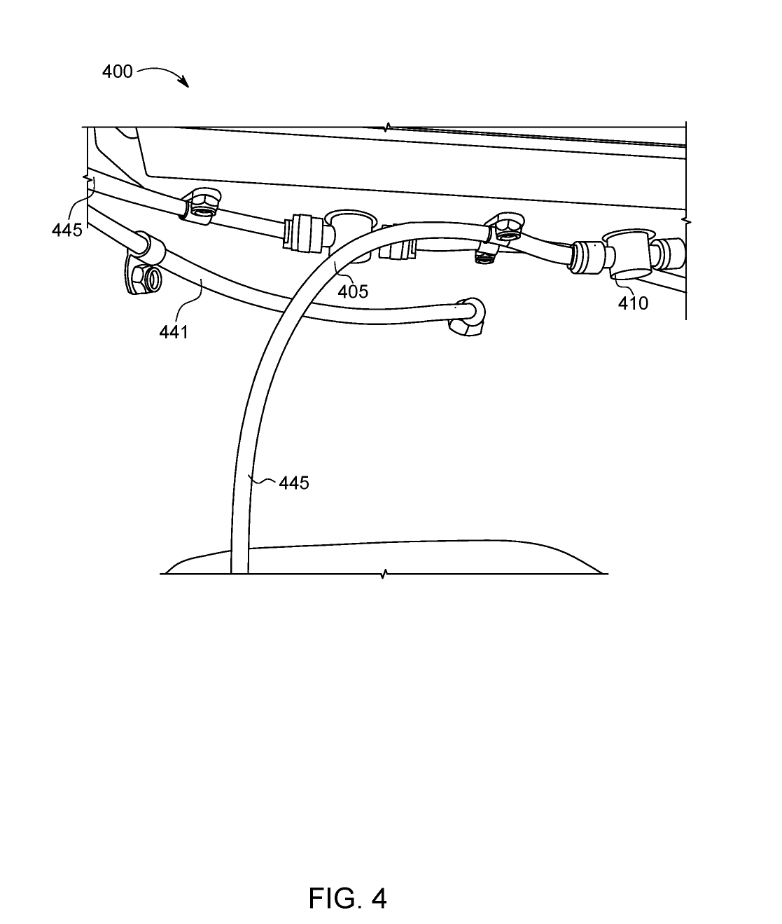

FIG. 4 shows an interior view 400 of the mobile water storage cabinet 105. Water valves 405 and 410 can be used to control water flow through water hoses 445. Air hose 441 supplies air going to syphon gun 145.

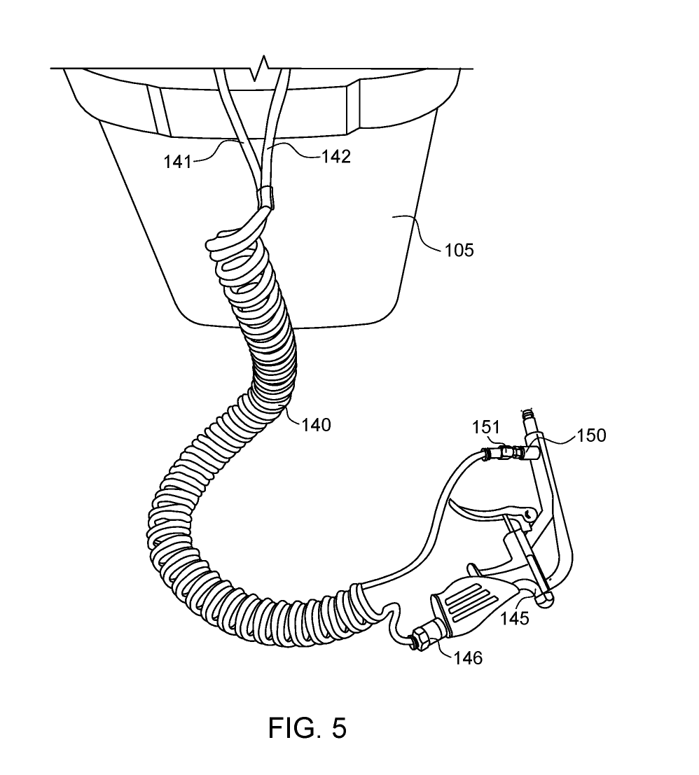

FIG. 5 shows an enlarged view of the intertwined hoses 140 and syphon gun 145. Intertwined hoses 140 can connect to water storage cabinet 105 by air line output 141 and water line output 142, which can connect to an air/syphon gun 145, with a pressurized air line input connection 146 supplying pressurized air to the air/syphon gun 145. The air/syphon gun 145 can include a separate syphon tip 150 attached to the front of the air gun to create the syphon gun 145, with water line input connection 151 connected to syphon tip 150. The attachable syphon tip 150 can interface the air gun 145 to create syphon gun 145. When air/syphon gun 145 activates, pressurized air can flow past water line input connection 151 to create a low pressure differential in the water supply lines, so that water can flow through the water line output 142 into the syphon gun 145 for ejecting under pressure from the syphon gun 145.

In operation, the disclosed air pressurized cleaning system uses less water compared to water pressurized system. The lower volume of water leads to lower water use and less waste water. It can also limit contamination due to contaminated waste water requiring additional washing to clean up.

In an embodiment, air compressor 110 can comprise a five gallon storage tank or larger with a 45-90 psi air pressure rating. To help minimize splatter in confined spaces, a lower air pressure can be used. A range of between about 45 to 90 psi can be used.

In an embodiment, the water storage tanks 310 can be of about five gallons or more or less. In an embodiment, the two water storage tanks 310 can be as small as ¾ gallons, or a single water tank 310 can be substituted. In use, water tanks 310 can include water and cleaner, such as soap. In some applications, water can be substituted by a fluid solvent/cleaner. Also, the fluid, whether water, solvent, or a mixture, can be at room temperature or heated. In a possible alternative embodiment, one or both water storage tanks 310 can include a heating element. Furthermore, the storage tanks 310 can be structurally incorporated into the mobile water storage cabinet 105 comprising a single, one piece apparatus.

In an embodiment, an air hose can be connected from an air compressor to an air gun with a syphon attachment, and a water supply comprising a mobile stored water source.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A mobile pressure wash system, comprising:
a mobile fluid storage cabinet comprised of at least one fluid storage tank coupled to an air compressor, and the air compressor supplying pressurized air into a pressurized air line;
the pressurized air line connecting to an air gun and a fluid line connecting to the air gun, the fluid line attached to the fluid storage tank;
the air gun comprising a syphon tip, the fluid line connecting to the syphon tip to facilitate a pressure differential to syphon fluid from the at least one fluid storage tank to eject fluid under pressure when pressurized air flows through the air gun and syphon tip;
wherein the air gun and the syphon together form a syphon gun.

2. The mobile pressure wash system of claim 1, wherein the fluid comprises water, a cleaner, or a combination of water and cleaner.

3. The mobile pressure wash system of claim 1, wherein the syphon tip comprises an attachable syphon tip interfaced with the air gun.

4. The mobile pressure wash system of claim 1, wherein the air compressor comprises an air pressure in the range of 45 to 90 psi and a five gallon pressure tank storing pressurized air.

5. The mobile pressure wash system of claim 1, wherein the fluid storage cabinet comprises at least two five gallon fluid storage tanks, a storage section, and hosing to facilitate movement of fluid through the system.

6. The mobile pressure wash system of claim 1, wherein the fluid storage cabinet further comprises valves to control and regulate fluid flow.

7. The mobile pressure wash system of claim 1, wherein the at least one fluid storage tank includes at least one storage tank in the range between ¾ gallon and five gallons.

8. The mobile pressure wash system of claim 1, wherein the fluid line and the air line comprise an intertwined hose connecting to the syphon gun.
